(19) United States
(12) Patent Application Publication
(10) Pub. No.: US 2005/0090564 A1
(43) Pub. Date: Apr. 28, 2005

(54) Compositions and treatments of bacterial vaginosis

(76) Inventors: Paul T. Wegener, New York, NY (US); Yukihiko Hara, Tokyo (JP)

Correspondence Address: ROBERT D. FISH;RUTAN & TUCKER LLP, 611 ANTON BLVD 14TH FLOOR, COSTA MESA, CA, 92626-1931, US

(21) Appl. No.: 10/974,253

(22) Filed: Oct. 26, 2004

Related U.S. Application Data
(60) Provisional application No. 60/515,485, filed on Oct. 28, 2003.

(51) Int. Cl. A01N 25/00

(52) U.S. Cl. 514/967

(57) ABSTRACT

Bacterial vaginosis is treated using methods and compositions that include one or more plant polyphenols as active ingredients. Preferred routes of administration of contemplated plant polyphenols include topical and oral administration, and particularly preferred plant polyphenols are prepared from green tea (e.g., Polyphenon E) and/or may include (−)-epigallocatechin gallate, (−)-epicatechin gallate, (−)-epigallocatechin, and (−)-epicatechin.

This application claims the benefit of U.S. provisional patent application with the Ser. No. 60/515,485, which was filed Oct. 28, 2003, and which is incorporated by reference herein.

### FIELD OF THE INVENTION

Treatment of bacterial infections, and especially of bacterial vaginosis.

### BACKGROUND OF THE INVENTION

Bacterial vaginosis (BV) is a genito-urinary tract infection that is typically caused by anaerobic bacteria, including Gardnerella vaginalis, Mobiluncus sp., Bacteroides sp. and Mycoplasma homini, and various compositions and methods for treatment of BV are known in the art. For example, metronidazole (1-(2-Hydroxy-1-ethyl)-2-methyl-5-nitroimidazole) is among the most effective and commonly prescribed drugs (see e.g., Ferris, D. G, Litaker, M. S, Woodward, L., Mathis, D., Hendrich, J. in J. Fam. Pract. 1995 November; 41(5):443-9). However, metronidazole has also been shown to be carcinogenic in mice and rats, and the potential risks may therefore outweigh the benefits of this drug. Alternatively, Clindamycin (7(S)-Chloro-7-deoxylincomycin) may be employed as therapeutic agent with relatively high efficacy. However, severe and life-threatening side effects have been reported, and again, the potential risks may outweigh the benefits of this drug.

In less common treatments, other antibiotics with pronounced specificity towards various anaerobic microorganisms can be used and include beta-lactam antibiotics, chloramphenicol, rifampin, tobramycin, vancomycin, virginiamycin, etc. However, numerous microorganisms are already resistant to these antibiotics (see e.g., Spiegel, C. A. in Antimicrob. Agents Chemother. 1987 February; 31 (2): 249-252). Moreover, most antibiotics typically also destroy desirable microorganisms that help maintain a healthy vaginal flora. In still other known treatments, a healthy vaginal flora is restored using microbial preparations to generate an environment that disfavors growth of pathogenic bacteria. However, such treatment typically requires several weeks to completion and is therefore often interrupted during the menstrual period.

Consequently, while numerous compositions and methods for treatment of bacterial vaginosis are known in the art, there is still a need to provide improved compositions and methods.

### SUMMARY OF THE INVENTION

The present invention is directed to compositions and methods of treatment of bacterial vaginosis in which a composition comprising a plant polyphenol or plant polyphenol mixture is used as an active ingredient.

Therefore, in one aspect of the inventive subject matter, a method of providing health care to a patient suffering from bacterial vaginosis comprises a step of providing a composition that includes a plant polyphenol, and another step of providing an instruction to administer the plant polyphenol containing composition in an amount effective to treat the bacterial vaginosis. Most preferably, the plant polyphenol is prepared from a green tea extract (e.g., polyphenon E), comprises a flavan-3-ol compound (synthetic or isolated from a plant), and/or is selected from the group consisting of (−)-epigallocatechin gallate, (−)-epicatechin gallate, (−)-epigallocatechin, and (−)-epicatechin.

Contemplated compositions are preferably topically applied, and especially suitable compositions are formulated as a suppository, a cream, a foam, and/or a liquid. Where desirable, the composition may also be included in a tampon. Alternatively, or additionally, contemplated compositions may also be formulated as orally administered compositions. Plant polyphenol amounts effective to treat the bacterial vaginosis are typically at least 50 mg/administration, more typically at least 250 mg/administration, and most typically at least 500 mg/administration.

In another aspect of the inventive subject matter, a composition for treatment of bacterial vaginosis comprises a plant polyphenol in a formulation for topical administration, wherein the plant polyphenol is present at a concentration effective to treat bacterial vaginosis. Therefore, in a further aspect of the inventive subject matter, a method of marketing a product for woman's health comprises a step of providing contemplated compositions and/or an information that a plant polyphenol (and most preferably polyphenon E and/or at least one of (−)-epigallocatechin gallate, (−)-epicatechin gallate, (−)-epigallocatechin, and (−)-epicatechin) is effective in treatment of bacterial vaginosis.

Various objects, features, aspects, and advantages of the present invention will become more apparent from the following detailed description of some of the preferred embodiments of the invention.

### DETAILED DESCRIPTION

The inventors discovered that bacterial vaginosis can be treated by topic and/or systemic administration of a plant polyphenol or mixture of various plant polyphenols. Most preferably, the plant polyphenols are isolated from green tea (Camellia sinensis) or grape seeds, and even more preferably comprise a mixture of plant polyphenols (e.g., Polyphenon E, commercially available from Mitsui Norin).

The term “plant polyphenol” as used herein refers to any naturally occurring or synthetic polyphenol that is commonly found in a plant. Therefore, particularly preferred plant polyphenols include flavan-3-ol compounds (e.g., (−)-epigallocatechin gallate (EGCG), (−)-epicatechin gallate (ECG), (−)-epigallocatechin (EGC), or (−)-epicatechin (EC)). As also used herein, the term “treat” or “treatment” refers to administration of contemplated compounds or compositions, typically in response to a diagnosis of bacterial vaginosis, which may result in complete or partial resolution of the bacterial vaginosis. Thus, the terms “treat” and “treatment” also include administrations that result in improvement in clinical parameters, and/or improvement in subjective well-being. Still further, the terms “treat” and “treatment” also refer to prophylactic administration of contemplated compounds or compositions to reduce likelihood of development or worsening of bacterial vaginosis.

In one especially preferred aspect of contemplated methods of use, a topical composition for vaginal administration comprises a mixture of green tea polyphenols (e.g., Polyphenon E) at a concentration of between about 10 wt % to about 20 wt %. Such compositions are typically formulated as a suppository with a melting point of between about 90° F. to about 100° F. and are most preferably packaged in a single dose under exclusion of oxygen. Suppositories are most preferably administered twice daily over at least fourteen consecutive days, or until the bacterial vaginosis is resolved.

With respect to the plant polyphenol, it should be recognized that numerous commercially available polyphenols other than Polyphenon E are known in the art, and all of those are deemed suitable for use herein. However, particularly preferred compositions will include those enriched in natural polyphenols from green tea (e.g.; green tea extract), or combinations of two or more of EGCG, ECG, EGC, and EC. Preferred plant polyphenols especially include tea catechin polyphenols represented by Formula (I) below in which R₁ is H or OH, and R₂ is H or a 3,4,5-trihydroxy benzoyl group;

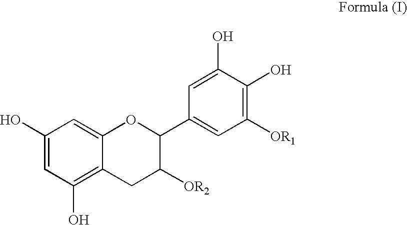

Particular examples of green tea catechins include: (−)epicatechin in which R₁ and R₂ are H; (−)epigallocatechin, in which R₁ is OH and R₂ is H; (−)epicatechin gallate, in which R₁ is H and R₂ is 3,4,5-trihydroxy benzoyl; and (−)epigallocatechin gallate, in which R₁ is OH and R₂ is 3,4,5-trihydroxy benzoyl. Additionally contemplated tea catechins include theaflavin, theaflavin monogallate A, theaflavin monogallate B, and theaflavin digallate.

The amount of plant polyphenols in contemplated formulations, and particularly for topical (i.e. vaginal) administration may vary considerably, however, it is generally preferred that the plant polyphenols will be present in an amount of between about 0.1 wt % (or less) to about 5.0 wt %, more typically between about 5.0 wt % to about 10 wt %, even more typically between about 10 wt % to about 25 wt %, and most typically between about 25 wt % to about 50 wt %, (or even more). The term “about” when used in conjunction with a numeral refers to that numeral +/− 10% absolute deviation, inclusive. For example, contemplated topical compositions will include the plant polyphenol in an amount that provides at least 50 mg, more preferably at least 250 mg, and most preferably at least 500 mg of the plant polyphenol per administration.

Suitable topical vehicles other than suppositories include those that can be applied as a cream, gel, or foam. Alternatively, it is contemplated that suitable formulations may be prepared as a liquid for application via a douche. There are numerous such topical formulations known in the art, and it is contemplated that all of such known formulations are suitable for use herein. In yet another particularly preferred aspect of the inventive subject matter, it is contemplated that the green tea extract is administered via a tampon, wherein the tampon comprises therapeutically effective amounts of the green tea extract. For example, a tampon may include contemplated plant polyphenols in a dried or otherwise at least partially dehydrated form. Alternatively, the polyphenols may also be incorporated into the tampon in a topical formulation as presented above. Consequently, it should be recognized that treatments according to the inventive subject matter can be continued throughout the menstrual cycle where needed.

Therefore, it should be recognized that compositions for treatment of bacterial vaginosis include those that comprise a plant polyphenol in a formulation for topical administration, wherein the plant polyphenol is present at a concentration effective to treat bacterial vaginosis. Such compositions may further include one or more antibiotics known for treatment of bacterial vaginosis, and particularly contemplated antibiotics include metronidazole, beta-lactam antibiotics, chloramphenicol, rifampin, tobramycin, vancomycin, and/or virginiamycin.

Alternatively, and more preferably additionally, contemplated plant polyphenols (e.g., in form of a green tea or green tea extract) may also be administered via oral route for treatment of bacterial vaginosis. For example, it is generally preferred that the oral administration comprises administration of Polyphenon E in a capsule. In other examples, the plant polyphenol may be administered as a single polyphenol (e.g., EGCG) or mixture of several isolated polyphenols, or as crude plant extract. In less preferred aspects, the plant polyphenols may also be orally administered as a tea. Oral dosages will preferably range from 1 mg to 50 mg, more preferably between about 50 mg to about 250 mg, and even more preferably between about 250 mg to several hundred milligrams (e.g., 500 mg, or even higher) per administration. Therefore, contemplated treatment kits will include a composition comprising a plant polyphenol (e.g., a green tea extract in oral and/or topical formulation), and an optional instruction to use the kit components at a schedule effective to treat bacterial vaginosis. Typical treatment schedules include those in which topical application is between once several times daily to weekly (e.g., twice daily, once daily, every other day, once weekly), or even less frequently, wherein topical and oral administration may be parallel, alternating, or at sequential.

Consequently, the inventors contemplate a method of providing health care to a patient suffering from bacterial vaginosis in which a composition is provided that includes a plant polyphenol, and in which an instruction is provided to administer the composition in an amount effective to treat the bacterial vaginosis. As discussed above, administration may be topical, oral, and most preferably a combination of topical and oral. Viewed from another perspective, the inventors also contemplate a method of marketing a product for women's health in which contemplated compositions are provided and/or in which information is provided that a plant polyphenol (most preferably comprising at least one of (−)-epigallocatechin gallate, (−)-epicatechin gallate, (−)-epigallocatechin, and (−)-epicatechin) is effective in treatment of bacterial vaginosis. Especially contemplated forms of information include printed information associated with the product (e.g., packaging insert or package containing contemplated compositions), or information provided to the user/public, which may be printed (e.g., advertisement), displayed (e.g., TV commercial), or in audible (e.g., radio commercial) and/or electronic form (e.g., as information provided via the Internet).

Thus, specific embodiments and applications of compositions and treatments of bacterial vaginosis have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

1. A method of providing health care to a patient suffering from bacterial vaginosis comprising providing a composition that includes a plant polyphenol and further providing an instruction to administer the composition in an amount effective to treat the bacterial vaginosis.

2. The method of claim 1 wherein the plant polyphenol is prepared from a green tea extract.

3. The method of claim 2 wherein the plant polyphenol comprises polyphenon E.

4. The method of claim 1 wherein the plant polyphenol comprises a flavan-3-ol compound.

5. The method of claim 1 wherein the plant polyphenol is selected from the group consisting of (−)-epigallocatechin gallate, (−)-epicatechin gallate, (−)-epigallocatechin, and (−)-epicatechin.

6. The method of claim 1 wherein the composition is a topically applied composition.

7. The method of claim 6 wherein the topically applied composition is formulated as at least one of a suppository, a cream, a foam, and a liquid.

8. The method of claim 6 wherein the topically applied composition is included in a tampon.

9. The method of claim 6 wherein the composition further comprises an oral composition.

10. The method of claim 1 wherein the composition comprises an oral composition.

11. The method of claim 1 wherein the amount effective is at least 50 mg of the plant polyphenol per administration.

12. The method of claim 1 wherein the amount effective is at least 250 mg of the plant polyphenol per administration.

13. The method of claim 1 wherein the amount effective is at least 500 mg of the plant polyphenol per administration.

14. A composition for treatment of bacterial vaginosis comprising a plant polyphenol in a formulation for topical administration, wherein the plant polyphenol is present at a concentration effective to treat bacterial vaginosis.

15. The composition of claim 14 wherein the formulation is selected from the group consisting of a suppository, a cream, a foam, and a liquid.

16. The composition of claim 14 wherein the formulation is included in a tampon.

17. The composition of claim 14 wherein the plant polyphenol is prepared from a green tea extract.

18. The composition of claim 14 wherein the plant polyphenol is selected from the group consisting of (−)-epigallocatechin gallate, (−)-epicatechin gallate, (−)-epigallocatechin, and (−)-epicatechin.

19. A method of marketing a product for women's health comprising at least one of a step of providing a product according to claim 14 and an information that a plant polyphenol is effective in treatment of bacterial vaginosis.

20. The method of claim 19 wherein the plant polyphenol is selected from the group consisting of (−)-epigallocatechin gallate, (−)-epicatechin gallate, (−)-epigallocatechin, and (−)-epicatechin.
